(19) United States
(12) Patent Application Publication
(10) Pub. No.: US 2025/0121439 A1
(43) Pub. Date: Apr. 17, 2025

(54) Turning bit for face-grooving and parting

(71) Applicant: KENNAMETAL INC., Latrobe, PA (US)

(72) Inventor: Igor Kaufmann, Fuerth (DE)

(21) Appl. No.: 18/913,207

(22) Filed: Oct. 11, 2024

(30) Foreign Application Priority Data
Oct. 12, 2023 (DE) 1020231279424

(51) Int. Cl. B23B 27/16

(52) U.S. Cl. CPC B23B 27/1611

(57) ABSTRACT

A turning bit for face-grooving or parting has a cutting edge that abuts a first lateral edge via a first cutting corner and abuts a second lateral edge via a second cutting corner. The first cutting corner and the second cutting corner are arranged mirror-symmetrically to a vertical plane (VE). Furthermore, the cutting edge has a centerpoint (P), which is arranged on the vertical plane (VE) and is distanced from an axial plane (AE).

### RELATED APPLICATION DATA

The present application claims priority pursuant to 35 U.S.C. § 119 (a) to German Patent Application Number 1020231279424 filed Oct. 12, 2023 which is incorporated herein by reference in its entirety.

### FIELD

The invention relates to a turning bit for face-grooving or parting.

### BACKGROUND

Such turning bits are known.

These turning bits are designed in particular for the so-called parting process. In this process, while a metallic workpiece is rotated, typically in the form of a rod, axial portions of the workpiece are parted off by means of the turning bit.

Straight turning bits typically have two cutting corners joined together by a straight cutting edge. The cutting edge extends perpendicular to the longitudinal axis of the turning bit so that the two cutting corners are arranged at the same height and thus penetrate the workpiece simultaneously during the parting.

What is disadvantageous about straight turning bits is that they leave behind a burr and a central stub on the workpiece and on the parted portion.

In order to part portions without a burr and without a central stub, so-called manual, i.e., left or right, turning bits are used, with which the left or right cutting corner protrudes accordingly in relation to the other cutting corner and thus penetrates first into the workpiece.

What is disadvantageous with manual turning bits is that their tool life and productivity is reduced due to the higher stress placed on the protruding corner. Furthermore, this cutting edge geometry produces an asymmetrical cutting force that results in a warpage of the turning bit and thus a reduced flatness of the parting surfaces.

### SUMMARY

The problem addressed by the invention is to provide a turning bit for face-grooving or parting which has a high tool life and parts of portions having a high quality.

The problem is solved by a turning bit for face-grooving and parting, having a body that extends along a longitudinal axis and comprises a retaining portion and at least one cutting portion. The retaining portion has a maximum width that is less than a maximum width of the at least one cutting portion. Furthermore, the at least one cutting portion comprises an upper face, a lower face arranged opposite the upper face, a first lateral face, a second lateral face arranged opposite the first lateral face, and an end face. The first lateral face and the second lateral face each extend from the lower face to the upper face, while the first lateral face abuts the upper face via a first lateral edge and the second lateral face abuts the upper face via a second lateral edge. The end face extends from the lower face to the upper face as well as from the first lateral face to the second lateral face and further abuts the upper face via a cutting edge. The cutting edge abuts the first lateral edge via a first cutting corner and abuts the second lateral edge via a second cutting corner. The first cutting corner and the second cutting corner are arranged mirror-symmetrically to a vertical plane extending along the longitudinal axis. Furthermore, the cutting edge has a centerpoint arranged on the vertical plane. The centerpoint is distanced from an axial plane towards the retaining portion. Furthermore, the first cutting corner and the second cutting corner are arranged in the axial plane, while the axial plane extends orthogonally to the longitudinal axis. As a result, the cutting edge comprises a first cutting edge portion and a second cutting edge portion extending from the centerpoint to the first and second cutting corners, respectively, and extending at an angle of greater than zero to one another.

It has been inventively found that, due to this geometry, the turning bit has particularly favorable cutting properties and a high tool life. Due to the fact that the two cutting edges are arranged on the same axial length and thus penetrate the workpiece simultaneously during parting, a symmetrical cutting force is produced, so that the turning bit remains dimensionally stable during parting and thus causes a high flatness of the parting surfaces. The cutting edge portions of the cutting edge, which are aligned with one another, cause portions to be parted without or with a reduced burr or without or with a reduced central stub.

In one embodiment, the at least one cutting portion is designed so as to be mirror-symmetrical to the vertical plane. This offers the advantage that the loads during parting are particularly homogeneously distributed, whereby the turning bit has a particularly long tool life.

Additionally or alternatively, the end face can form a tool flank for the cutting edge, wherein the tool flank has a relief angle in the range of 5° to 12°. As a result, the friction between the turning bit and the workpiece is low.

In a further embodiment, the end face comprises a first end face portion and a second end face portion, each abutting the cutting edge and each extending at a setting angle in the range of 6° to 20° in relation to the axial plane. Due to this geometry, the cutting edge has particularly favorable cutting properties, which in particular causes reduced burr formation.

The first end face portion can abut the first lateral face via a first end edge, and the second end face portion can abut the second lateral face via a second end edge. In particular, the first end edge can abut the first cutting corner and the second end edge can abut the second cutting corner. In this way, the cutting portion is designed particularly robustly.

Furthermore, it can be provided that the cutting edge, the first lateral edge, and the second lateral edge extend in a common plane, whereby the loads during parting are particularly homogeneously distributed across the cutting portion.

In an alternative embodiment, the centerpoint is distanced from a horizontal plane towards the lower face. The first cutting corner and the second cutting corner are arranged in the horizontal plane extending parallel to the longitudinal axis. This geometry favors an advantageous chip formation.

The cutting edge can have a concave shape, which, in the turning process, causes the formation of chips with a particularly small chip curvature radius.

According to one embodiment, the upper face forms a concave chip well, thereby removing the chips particularly quickly and with little friction during the parting process.

According to a further embodiment, the chip well extends up to the cutting edge. In this way, the chip formation and chip removal are particularly advantageous.

Further advantages and features will emerge from the following description and from the accompanying drawings.

### BRIEF DESCRIPTION OF THE DRAWINGS

The figures show:

FIG. 1 in a perspective view, a turning bit according to the invention, according to a first embodiment,

FIG. 2 in a lateral view, the turning bit from FIG. 1,

FIG. 3 in a frontal view, the turning bit from FIG. 1,

FIG. 4 in a top-down view, the turning bit from FIG. 1,

FIG. 5 a cutting portion of the turning bit in a sectional view along the plane E-E in FIG. 4,

FIG. 6 in a perspective view, a turning bit according to the invention, according to a further embodiment,

FIG. 7 in a lateral view, the turning bit from FIG. 6,

FIG. 8 in a frontal view, the turning bit from FIG. 6,

FIG. 9 in a top-down view, the turning bit from FIG. 6,

FIG. 10 a cutting portion of the turning bit in a sectional view along the plane E-E in FIG. 9,

FIG. 11 in a perspective view, a turning bit according to the invention, according to a further embodiment,

FIG. 12 in a lateral view, the turning bit from FIG. 11,

FIG. 13 in a frontal view, the turning bit from FIG. 11,

FIG. 14 in a top-down view, the turning bit from FIG. 11, and

FIG. 15 a cutting portion of the turning bit in a sectional view along the plane E-E in FIG. 14,

### DETAILED DESCRIPTION

The detailed description below in conjunction with the accompanying drawings, in which like numerals refer to like elements, is intended as a description of various embodiments of the disclosed subject-matter and is not intended to show the individual embodiments. Any embodiment described in this disclosure serves as an example or for illustrative purposes only and should not be construed as being preferred or advantageous over other embodiments.

All features disclosed below in relation to the exemplary embodiments and/or accompanying figures can be combined, alone or in any sub-combination, with features of aspects of the present disclosure, including features of preferred embodiments, provided that the resulting combination of features is sensible to those skilled in the art.

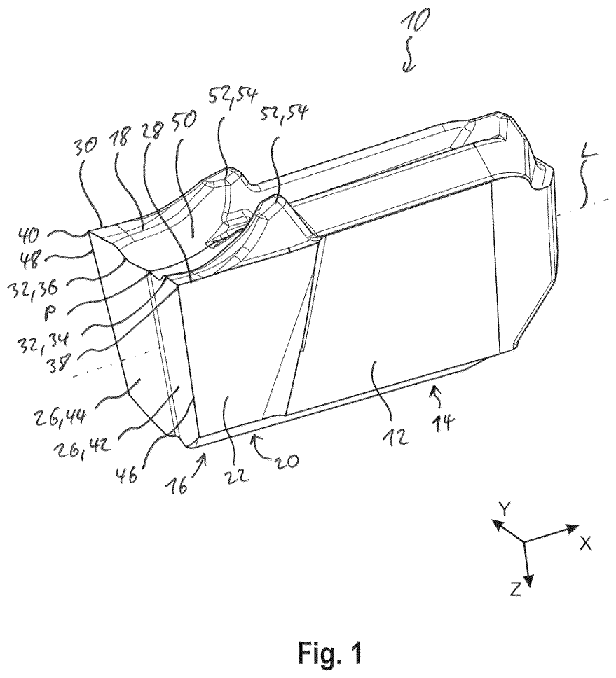

In FIG. 1, a turning bit 10 is shown, having a body 12 comprising a retaining portion 14 and a cutting portion 16.

The retaining portion 14 and the cutting portion 16 are each cuboid in form and extend along a common longitudinal axis L, which in the illustrated exemplary embodiment runs in the X direction.

In an alternative embodiment, the body 12 can comprise a plurality of cutting portions 16.

For example, in one embodiment, the body 12 comprises two cutting portions 16 arranged at opposite axial ends of the body 12 and connected to one another via the retaining portion 14.

In particular, in one embodiment having a plurality of cutting portions 16, these can be identical to one another.

Additionally or alternatively, in embodiments having a plurality of cutting portions 16, the turning bit 10 can be designed as an indexable insert 10, such that only a part of the cutting portions 16, in particular only a single cutting portion 16, are provided for the simultaneous machining of a workpiece.

The turning bit 10 is configured for parting, in particular of metal parts.

In principle, a turning bit 10 configured for parting is also configured for face-grooving.

In an alternative embodiment, the turning bit 10 can be configured for face-grooving.

For face-grooving or parting, the turning bit 10 is clamped or otherwise fixed in a tool holder (not shown) by means of the retaining portion 14.

Furthermore, the retaining portion 14 has a maximum width b that is less than a maximum width B of the cutting portion 16 in order to avoid contact of the retaining portion 14 with the workpiece when, during parting, the turning bit 10 cuts through a workpiece by means of the cutting portion 16.

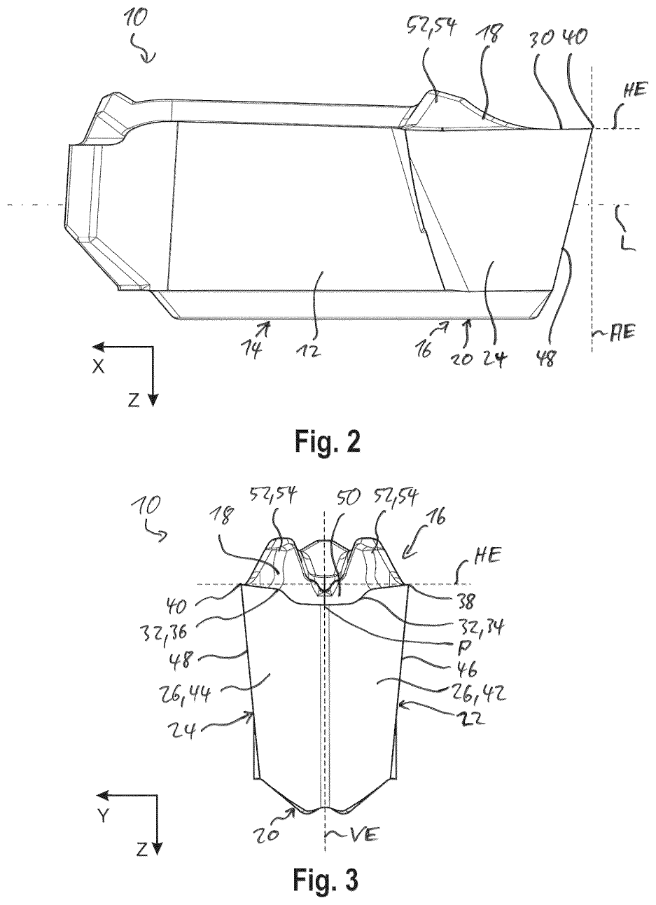

The at least one cutting portion 16 comprises an upper face 18, a lower face 20 arranged opposite the upper face 18, a first lateral face 22, a second lateral face 24 arranged opposite the first lateral face 22 (see FIG. 2), and an end face 26.

The first lateral face 22 extends from the lower face 20 to the upper face 18. The intersection line at which the first lateral face 22 abuts the upper face 18 forms a first lateral edge 28.

The second lateral face 24 extends from the lower face 20 to the upper face 18. The intersection line at which the second lateral face 24 abuts the upper face 18 forms a second lateral edge 30.

In the present embodiment, the first lateral edge 28 and the second lateral edge 30 form auxiliary cutting edges of the turning bit 10.

The end face 26 extends from the lower face 20 to the upper face 18 and from the first lateral face 22 to the second lateral face 24. The intersection line at which the end face 26 abuts the upper face 18 forms a cutting edge 32, which is the main cutting edge of the turning bit 10.

The cutting edge 32 has a centerpoint P arranged on a vertical plane VE (see FIG. 3) extending along the longitudinal axis L as well as in the Z direction.

The centerpoint P divides the cutting edge 32 into a first cutting edge portion 34 and a second cutting edge portion 36.

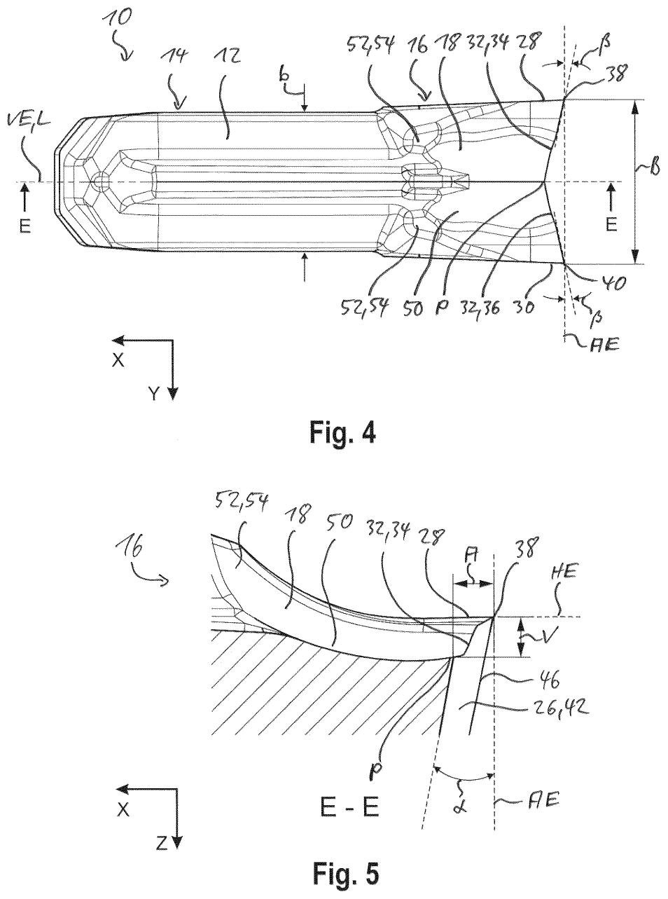

The first cutting edge portion 34 extends from the centerpoint P to the first lateral edge 28 (see FIG. 4) and abuts it via a first cutting corner 38.

The second cutting edge portion 36 extends from the centerpoint P to the second lateral edge 30 and abuts it via a second cutting corner 40.

In this context, the end face 26 has a first end face portion 42 (see FIG. 1) and a second end face portion 44.

Here, the first end face portion 42 abuts the first cutting edge portion 34 and, via a first end edge 46, abuts the first lateral face 22, while the second end face portion 44 abuts the second cutting edge portion 36 and, via a second end edge 48, abuts the second lateral face 24.

In the present embodiment, the first end edge 46 extends from the lower face 20 to the first cutting corner 38 and the second end edge 48 extends from the lower face 20 to the second cutting corner 40.

The end face portions 42, 44 are planar and, when viewed in an X-Z plane, each extend at a relief angle α (see FIG. 5) of 7° in relation to an axial plane AE, which extends in the Y and Z directions and in which the first and second cutting corners 38, 40 are arranged. In this way, the first end face portion 42 forms a tool flank for the first cutting edge portion 34 and the second end face portion 44 forms a tool flank for the second cutting edge portion 36.

In an alternative embodiment, the relief angle α can have a value in the range of 1° to 30°, in particular in the range of 5° to 12°.

Furthermore, the end face portions 42, 44, when viewed in an X-Y plane, each extend at a setting angle β (see FIG. 4) of 11° in relation to the axial plane AE.

In an alternative embodiment, the setting angle β can have a value in the range of 1° to 60°, in particular in the range of 6° to 20°.

The centerpoint P is thereby spaced apart from the axial plane AE by a distance A (see FIG. 5) in the X direction towards the retaining portion 14. In other words, the centerpoint P is rearwardly offset from the cutting corners 38, 40.

Furthermore, the centerpoint P is spaced apart by a distance V in the Z direction towards the lower face 20 from a horizontal plane HE, which extends parallel to the longitudinal axis L and in which the first and second cutting corners 38, 40 are arranged. This means that the centerpoint P is offset downwards from the cutting corners 38, 40.

In this context, the lateral edges 28, 30 extend in the horizontal plane HE (see FIG. 2).

In the illustrated embodiment, the cutting edge 32 is concavely shaped with a view in the X direction (see FIG. 3).

The first cutting edge portion 34 and the second cutting edge portion 36 are each designed in stepped or wave-like fashion.

In an alternative embodiment, the first cutting edge portion 34 and the second cutting edge portion 36 can each have any shape.

The cutting portion 16 comprises a concave-shaped chip well 50 as well as a chip-guiding element 52 in the form of two extensions 54 formed by the upper face 18.

The chip well 50 extends in the X direction from the cutting edge 32 up to the chip-guiding element 52.

In the present embodiment, the turning bit 10 is designed so as to be mirror-symmetrical to the vertical plane VE.

In an alternative embodiment, the turning bit 10 can be arbitrary in design, as long as at least the first cutting corner 38 and the second cutting corner 40 are arranged mirror-symmetrically to the vertical plane VE and thus at the same axial length.

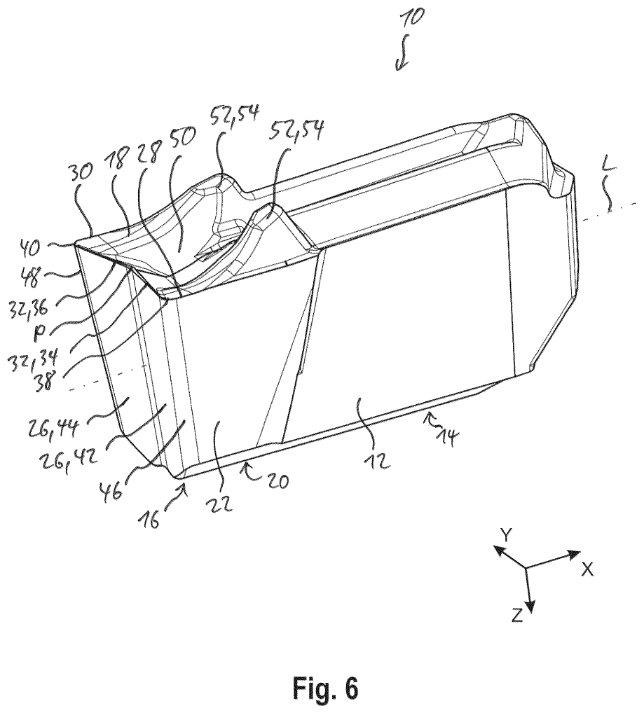

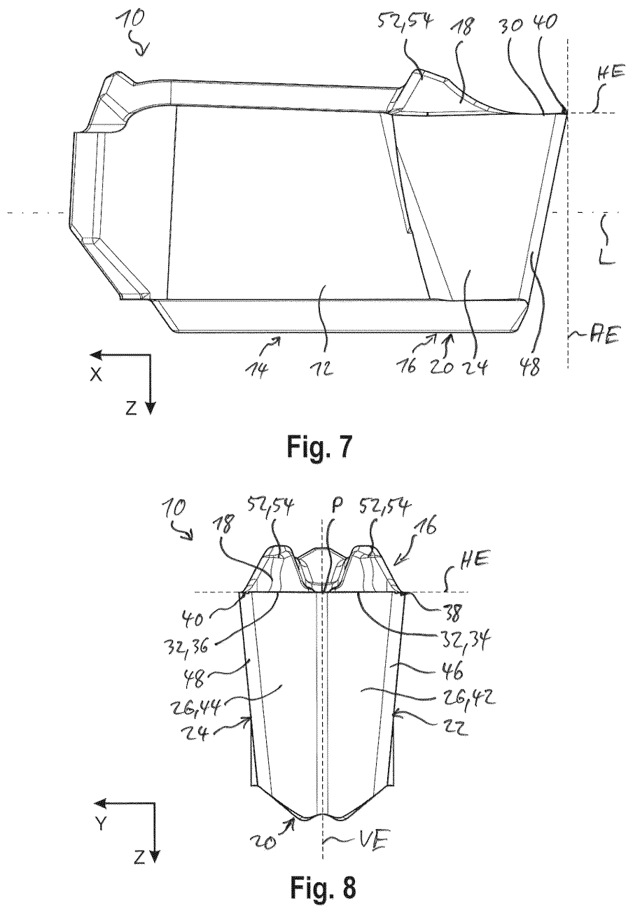

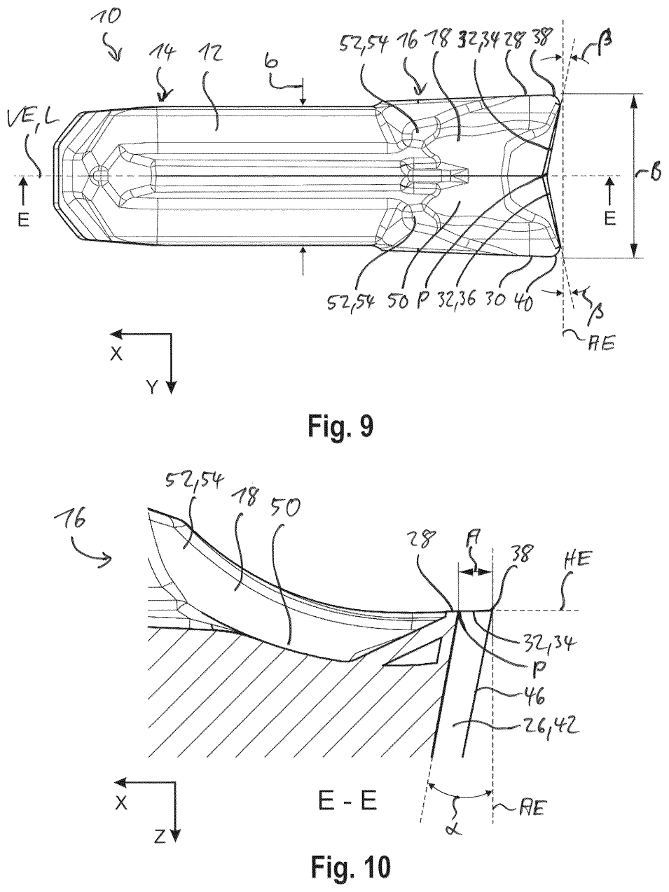

A turning bit 10 according to a further embodiment will now be described based on FIGS. 6 through 10. For the components known from the above embodiment, the same reference numerals are used, and reference is made in this respect to the above explanations.

By contrast to the embodiment shown in FIGS. 1 to 5, in the turning bit 10 shown in FIGS. 6 to 10, the centerpoint P is arranged in the horizontal plane HE. That is to say, the distance V is zero.

Furthermore, the cutting edge portions 34, 36 each extend in a straight line from the centerpoint P to the first and second cutting corners 38, 40, respectively.

As a result, the cutting edge portions 34, 36 and the lateral edges 28, 30 extend in the horizontal plane HE. Accordingly, the cutting corners 38, 40 and the centerpoint P are also arranged in the horizontal plane HE.

Furthermore, in the present embodiment, the end edges 46, 48 have a rounding (see FIG. 6).

Accordingly, the cutting corners 38, 40 are also rounded so that they can withstand loads longer.

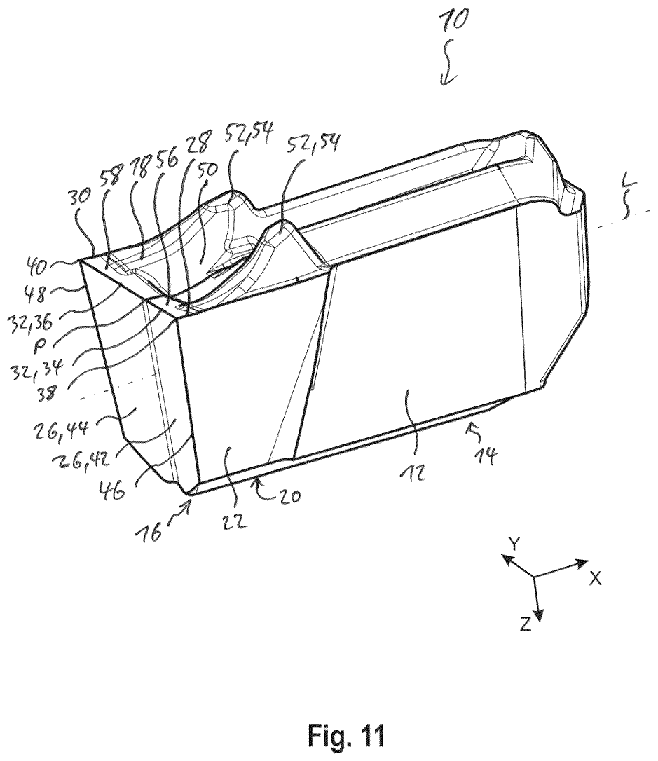

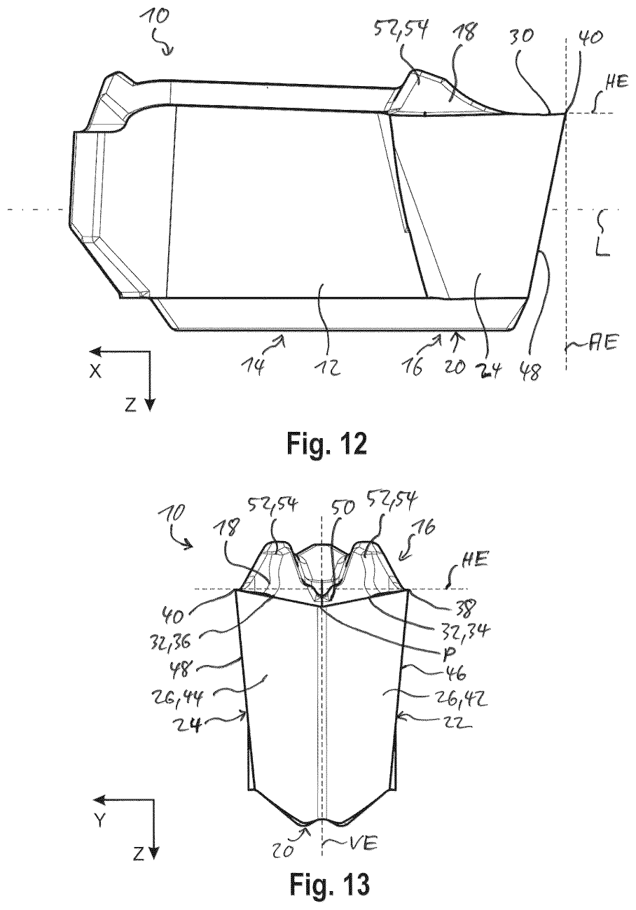

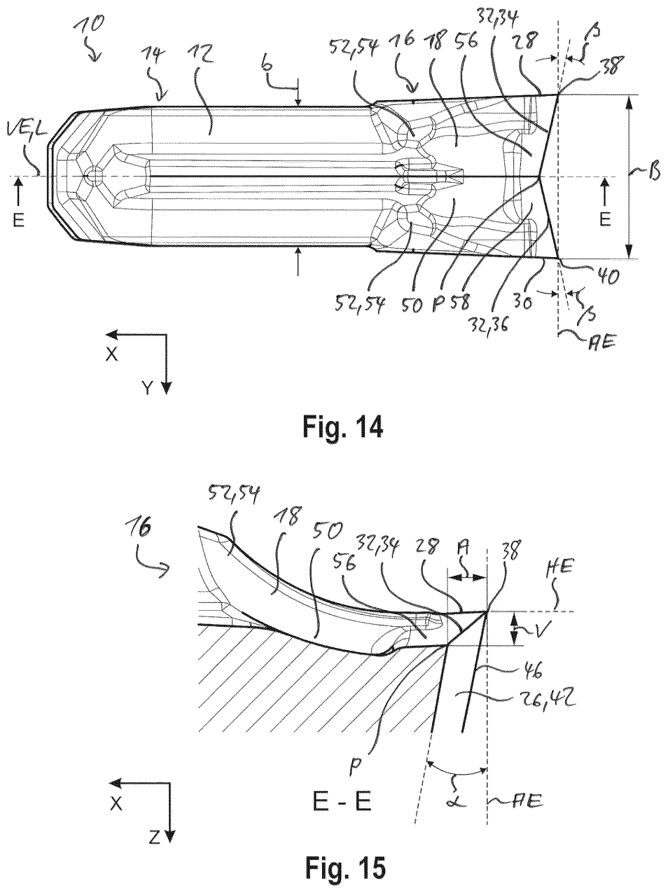

A turning bit 10 according to a further embodiment will now be described based on FIGS. 11 through 15. For the components known from the above embodiments, the same reference numerals are used, and reference is made in this respect to the above explanations.

By contrast to the embodiment shown in FIGS. 1 to 5, in the turning bit 10 shown in FIGS. 11 to 15, the cutting edge portions 34, 36 each extend in a straight line from the centerpoint P to the first and second cutting corners 38, 40, respectively.

Furthermore, the upper face 18 comprises a first upper face portion 56 and a second upper face portion 58 extending from the cutting edge 32 towards the chip well 50, in particular in the X direction.

The first upper face portion 56 abuts the first end face portion 42 via the first cutting edge portion 34 and abuts the first lateral face 22 via the first lateral edge 28.

The second upper face portion 58 abuts the second end face portion 44 via the second cutting edge portion 36 and abuts the second lateral face 24 via the second lateral edge 30.

In this context, the upper face portions 56, 58 are each planar in form.

Due to the upper face portions 56, 58, the cutting edge 32 is particularly robust, whereby the tool life of the turning bit 10 is particularly long.

In all embodiments, in this manner, a turning bit 10 is provided which offers improved cutting properties and reduced formation of burrs during face-grooving or parting.

Furthermore, the turning bit 10 has a high tool life.

In addition, the geometry of the turning bit 10 favors the formation of chips with a particularly small chip curvature radius, thereby removing the chips with marginal friction.

| | Reference numerals |
|---|---|
| 10 | Turning bit |
| 12 | Body |
| 14 | Retaining portion |
| 16 | Cutting portion |
| 18 | Upper face |
| 20 | Lower face |
| 22 | First lateral face |
| 24 | Second lateral face |
| 26 | End face |
| 28 | First lateral edge |
| 30 | Second lateral edge |
| 32 | Cutting edge |
| 34 | First cutting edge portion |
| 36 | Second cutting edge portion |
| 38 | First cutting corner |
| 40 | Second cutting corner |
| 42 | First end face portion |
| 44 | Second end face portion |
| 46 | First end edge |
| 48 | Second end edge |
| 50 | Chip well |
| 52 | Chip-guiding element |
| 54 | Extensions |
| 56, 58 | Upper face portions |

1. A turning bit for face-grooving and parting, having a body that extends along a longitudinal axis (L) and comprises a retaining portion and at least one cutting portion,
wherein the retaining portion has a maximum width (b) that is less than a maximum width (B) of the at least one cutting portion,
wherein the at least one cutting portion comprises an upper face, a lower face arranged opposite the upper face, a first lateral face, a second lateral face arranged opposite the first lateral face, and an end face,
wherein the first lateral face and the second lateral face each extend from the lower face to the upper face, wherein the first lateral face abuts the upper face via a first lateral edge and the second lateral face abuts the upper face via a second lateral edge,
wherein the end face extends from the lower face to the upper face as well as from the first lateral face to the second lateral face, wherein the end face abuts the upper face via a cutting edge,
wherein the cutting edge abuts the first lateral edge via a first cutting corner) and abuts the second lateral edge via a second cutting corner,
wherein the first cutting corner and the second cutting corner are arranged mirror-symmetrically to a vertical plane (VE) extending along the longitudinal axis (L),
wherein the cutting edge has a centerpoint (P) arranged on the vertical plane (VE), wherein the centerpoint (P) is distanced from an axial plane (AE) towards the retaining portion, wherein the first cutting corner and the second cutting corner are arranged in the axial plane (AE) and the axial plane (AE) extends orthogonally to the longitudinal axis (L).

2. The turning bit according to claim 1, wherein the at least one cutting portion is designed so as to be mirror-symmetrical to the vertical plane (VE).

3. The turning bit according to claim 1, wherein the end face forms a tool flank for the cutting edge, wherein the tool flank has a relief angle (a) in the range of 5° to 12°.

4. The turning bit according to claim 1, wherein the end face comprises a first end face portion and a second end face portion, which respectively abut the cutting edge and each extend at a setting angle (B) in the range of 6° to 20° in relation to the axial plane (AE).

5. The turning bit according to claim 4, wherein the first end face portion abuts the first end face via a first end edge and the second end face portion abuts the second end face via a second end edge.

6. The turning bit according to claim 1, wherein the cutting edge, the first lateral edge, and the second lateral edge extend in a common plane (HE).

7. The turning bit according to claim 1, wherein the centerpoint (P) is distanced from a horizontal plane (HE) towards the lower face, wherein the first cutting corner and the second cutting corner are arranged in the horizontal plane (HE) and the horizontal plane (HE) extends parallel to the longitudinal axis (L).

8. The turning bit according to claim 7, wherein the cutting edge has a concave shape.

9. The turning bit according to claim 1, wherein the upper face forms a concave chip well.

10. The turning bit according to claim 9, wherein the chip well extends up to the cutting edge.

11. The turning bit according to claim 5, wherein the first end edge abuts the first cutting corner and the second end edge abuts the second cutting corner.
